(19) United States
(12) Patent Application Publication
(10) Pub. No.: US 2012/0210243 A1
(43) Pub. Date: Aug. 16, 2012

(54) WEB CO-NAVIGATION

(76) Inventors: Gavin Andrew Ross Uhma, Sydney (CA); Jevon MacDonald, Halifax (CA)

(21) Appl. No.: 13/372,411

(22) Filed: Feb. 13, 2012

Related U.S. Application Data
(60) Provisional application No. 61/442,105, filed on Feb. 11, 2011.

(51) Int. Cl. G06F 3/01; G06F 15/16

(52) U.S. Cl. 715/744

(57) ABSTRACT

A system incorporating techniques described in this paper includes a shared session server system that enables clients to view and interact with content simultaneously. The system enables a first shared session client to send an event stream sufficient to depict results of interaction with the content at a second shared session client.

### CROSS-REFERENCE TO RELATED APPLICATIONS

This application claims priority to U.S. provisional Ser. No. 61/442,105 filed Feb. 11, 2011, entitled “Webpage Sharing and Collaboration System, Method, and Storage Medium,” which is incorporated by reference.

### BACKGROUND

Browsing the Web is a solitary experience. It is possible to follow recent posts in comments sections of web pages or follow a blog, but the experience, while relatively up-to-date, is still an observation of content that is left behind by another; it is historical content. Existing systems for sharing an collaboration of webpages and websites limit users to transmitting the image of one system's desktop (the desktop of the “primary user”) to one or more other systems. In such systems, a primary system installs software that transmits images of the primary system's desktop to other users. The primary user essentially sends the results of a browsing session as it happens to other users. The other users are relegated to bystanders viewing the results of the primary user's session.

The foregoing example of the state of the art is intended to be illustrative and not exclusive.

### SUMMARY

A system incorporating techniques described in this paper includes sharing captured events and context around the events when browsing web content with participants in a shared browsing session. The techniques are applicable to systems that enable interaction with a shared web page by multiple users in real-time. A system implemented in accordance with the techniques can include a web co-navigation system that couples a web content server to real-time shared session client devices.

### BRIEF DESCRIPTION OF THE DRAWINGS

FIG. 1 depicts an example of system for providing a shared content session.

FIG. 2 depicts an example of a web co-navigation system.

FIG. 3 depicts a flowchart of an example of a method for sharing interactions to web content.

FIG. 4 depicts a flowchart of an example of a method for receiving shared interactions to web content.

FIG. 5 depicts a flowchart of an example of a method for modifying content for compatibility in a shared content session.

FIG. 6 depicts an example of a system for masking protected fields in a shared content session.

FIG. 7 depicts a flowchart of an example of a method for streaming real-time mouse position.

FIG. 8 depicts a screenshot of an example of a web page with a first shared connection client mouse cursor and a second (local) shared connection client mouse cursor.

FIG. 9 depicts a flowchart of an example of a method for modifying source code of a webpage to add an annotation.

FIG. 10 depicts a flowchart of an example of a method for determining session ID and remote URL from a requested URL.

FIG. 11 depicts a flowchart of an example of a method for downloading a remote page.

FIG. 12 depicts a flowchart of an example of a method for deriving HTTP headers from a URL and HTTP method.

FIG. 13 depicts a flowchart of an example of a response to a shared connection client.

FIG. 14 depicts a flowchart of an example of a method for loading a session cache or querying a default search engine.

FIG. 15 depicts a flowchart of an example of a method for loading a session cache or querying a default search engine.

FIG. 16 depicts a flowchart of an example of requesting a new webpage.

FIG. 17 depicts a computer system on which components described in this paper could be implemented.

FIG. 18 depicts a state diagram of a shared content synchronization cache.

FIG. 19 depicts a flowchart of an example of a method for handling iframes.

### DETAILED DESCRIPTION

Specific implementations of the invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. For the purpose of clarity, technical material that is known in the technical fields related to the invention has not been described in detail so that the invention is not unnecessarily obscured.

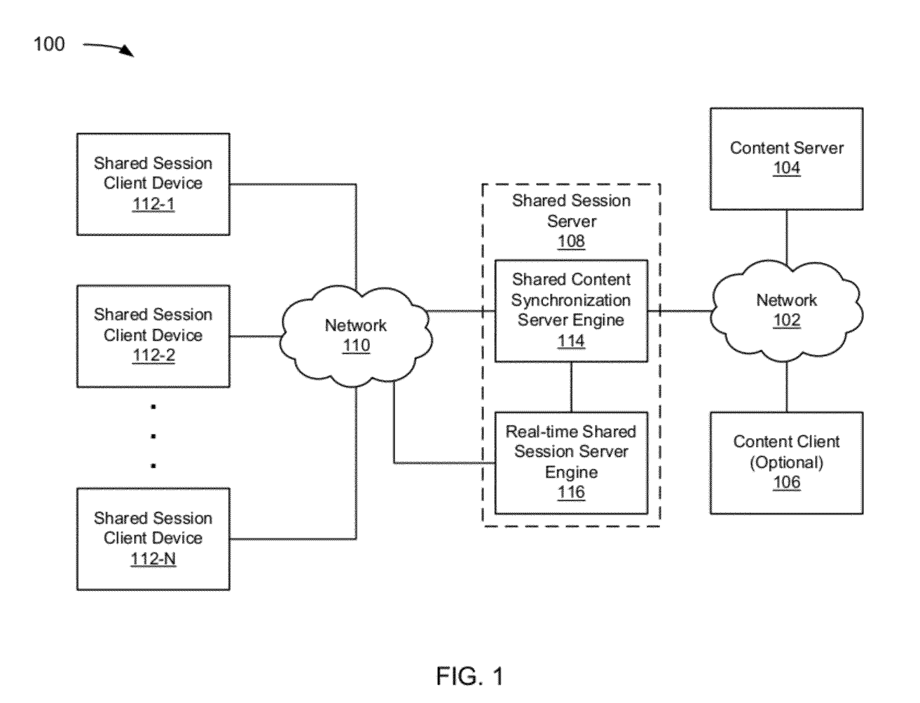

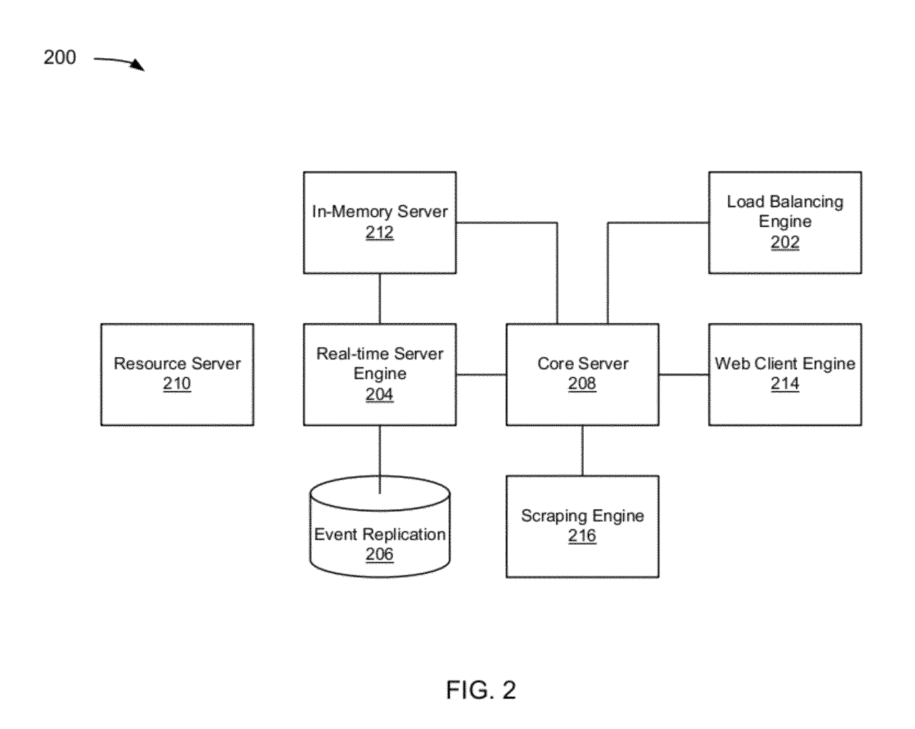

FIG. 1 depicts an example of a system 100 for providing a shared content session. In the example of FIG. 1, the system 100 includes a network 102, a content server 104, a content client 106, a shared session server system 108, a network 110, and shared session client devices 112-1 to 112-N (collectively referred to as the shared session client devices 112).

In the example of FIG. 1, the network 102 is intended to include an applicable communications network such as the Internet, a public switched telephone network (PSTN), an infrastructure network (e.g., private LAN), or some other network that is capable of acting as a link between the various components depicted in FIG. 1. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). A PSTN can include wired or wireless (e.g., 4G/3G/2G) network operated by, for example, a central provider. An infrastructure network that offers wireless connectivity can include wired and wireless devices in communication with wireless access points (WAPs). The wired and wireless devices can include various network equipment including by way of example but not limitation a cable network head end, a DSL network DSLAM, a fiber network aggregation node, and/or a satellite network aggregation node.

In the example of FIG. 1, the content server 104 is coupled to the network 102. The content server 104 can be implemented as a known or convenient content server, such as a web content server.

In the example of FIG. 1, the content client 106 is coupled to the network 106. The content client 106 can be implemented as a known or convenient content client. The content client 106 is optional because the techniques described in this paper are applicable to co-navigating clients, whereas the content client 106 is intended to juxtapose a content client that may be operating in accordance with known or convenient solo session processes in a time period overlapping a shared session involving the same web content.

In the example of FIG. 1, the shared session server system 108 is coupled to the network 102. The shared session server system 108 includes a shared content synchronization server engine 114 and a real-time shared session server engine 116. As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, in operation, the shared session server system 108 parses a request received from, for example, the shared session client device 112-1. In a specific implementation, the request includes a session ID/channel, a search term, or a URL. The shared session server system 108 can use this information to determine how to respond to the shared session client device 112-1 from a number of possible options including, for example, downloading a webpage corresponding to the URL, downloading a webpage corresponding to a default search engine's results of the search term, or retrieving the cached webpage from a data store corresponding to the session ID. If a webpage is downloaded as opposed to being retrieved from cache, source code of the webpage is modified to convert all URLs capable of changing location, including but not limited to links, forms, and URLs within scripts, to a structure compatible with the aforementioned parsing technique. Additionally, the source code can be modified to direct the shared session client device 112-1 to download the webpage's resources from the content server 104 or to download the webpage's resources from the shared session server 108 (e.g., from a resource server).

Exceptions may be made or rules defined to remove or modify source code that may prevent the content from displaying and/or behaving exactly as it would if downloaded from the content server 104 by the content client 106 in an unshared session. In a specific implementation, collaboration features, user interface, and other features are added to the source code by the shared session server 108 prior to provisioning to the shared session client devices 112. The modified source code can be stored for later retrieval. The modified source code or the cached content is sent to the shared session client devices 112.

The shared session client devices 112 are notified of changes to content and are instructed to make a request to the shared session server 108 with a URL structured to download the shared content from the cache. Users of the shared session client devices 112 can interact with the shared content through mouse, keyboard, and other events (e.g. hovers, scrolling, etc.) and/or using collaboration features. The shared session client device 112-1 (or other one of the shared session client devices 112) can send events or features that modify the shared content structure, e.g., a document object model (“DOM”) of the shared content, to the shared session server 108, which are distributed to and replicated on the other shared session client devices 112 (e.g. by unicast, multicast, or broadcast). In a specific implementation, an event, function, or change to the shared content structure that originates on one of the shared session client devices 112 can be replicated on a server instance of the shared content and the shared session server 108 can store the resulting content structure for later retrieval.

In the example of FIG. 1, the network 110 is coupled to the shared session server system 108. The network 110 is depicted as distinct from the network 102 despite the fact that the network 110 can be considered part of the network 102. The distinction is drawn for illustrative purposes. In a specific implementation, the network 110 includes a wireless network. In such an implementation, one or more of the shared session client devices 112 can be implemented as a station. At a minimum, a station will include a processor, memory (though the memory could be implemented in the processor), a radio, and a radio interface (though the radio interface could be implemented as “part of” the radio). In order to make a station useful in a user device implementation, stations implemented on user devices will typically have at least one input device and at least one output device, including input and output interfaces, if applicable.

A station, as used herein, may be referred to as a device with a media access control (MAC) address and a physical layer (PHY) interface to the wireless medium that comply with, e.g., cellular standards or the IEEE 802.11 standard. A station can be described as “IEEE 802.11-compliant” when compliance with the IEEE 802.11 standard is intended to be explicit. (I.e, a device acts as described in at least a portion of the IEEE 802.11 standard.) One of ordinary skill in the relevant art would understand what the IEEE 802.11 standard comprises today and that the IEEE 802.11 standard can change over time, and would be expected to apply techniques described in this paper in compliance with future versions of the IEEE 802.11 standard if an applicable change is made. IEEE Std 802.11™-2007 (Revision of IEEE Std 802.11-1999) is incorporated by reference. IEEE 802.11k-2008, IEEE 802.11n-2009, IEEE 802.11p-2010, IEEE 802.11r-2008, IEEE 802.11w-2009, and IEEE 802.11y-2008 are also incorporated by reference. In alternative embodiments, one or more of the wireless devices may comply with some other standard or no standard at all, and may have different interfaces to a wireless or other medium. It should be noted that not all standards refer to wireless devices as “stations,” but where the term is used in this paper, it should be understood that an analogous unit will be present on all applicable wireless networks. Thus, use of the term “station” should not be construed as limiting the scope of an embodiment that describes wireless devices as stations to a standard that explicitly uses the term, unless such a limitation is appropriate in the context of the discussion.

The network 110, if it includes a wireless network, will typically include an internetworking unit (IWU) that interconnects wireless devices on the network 110 with another network, such as a wired LAN, and to the network 102. The IWU is sometimes referred to as a wireless access point (WAP). In the IEEE 802.11 standard, a WAP is also defined as a station. Thus, a station can be a non-WAP station or a WAP station. In a cellular network, the WAP is often referred to as a base station. The network 110 can be implemented using any applicable technology, which can differ by network type or in other ways. The network 110 can be of any appropriate size (e.g., metropolitan area network (MAN), personal area network (PAN), etc.). Broadband wireless MANs may or may not be compliant with IEEE 802.16, which is incorporated by reference. Wireless PANs may or may not be compliant with IEEE 802.15, which is incorporated by reference. The network 110 can be identifiable by network type (e.g., 2G, 3G, WiFi), service provider, WAP/base station identifier (e.g., WiFi SSID, base station and sector ID), geographic location, or other identification criteria.

In the example of FIG. 1, the shared session client devices 112 are coupled to the network 110. As has been described, one or more of the shared session client devices 112 can be implemented as a station. For example, the shared session client devices 112 can be implemented as wireless user devices such as a phone, personal data assistant (PDA), computing device, laptop, net book, tablet, camera, music/media player, GPS device, networked appliance, or some other known or convenient user device; and/or various types of intermediate networking devices. The shared session client devices 112 may or may not be wireless devices.

FIG. 2 depicts an example of a web co-navigation system 200. The system 200 includes a load balancing engine 202, a real-time server 204, an event replication datastore 206, a core server 208, a resource server 210, an in-memory data server 212, a web client engine 214, and a scraping engine 216. One aspect of the disclosed subject matter is the real-time shared browsing of web pages including mouse events (e.g. clicks, moves, hovers, etc.), annotations (e.g. highlights, comments, drawing, arrows, lines, etc.), and communication (chat, voice, etc.). In another aspect of the disclosed subject matter shared browsing sessions are created and a history of all pages visited is stored persistently along with all user activity (mouse events, annotations, communications, etc.) during the session. In yet another aspect of the disclosed subject matter all changes to the document structure (including but not limited to text, attribute, node modifications, etc.) are replicated on the server where they are stored persistently for later retrieval. An additional aspect of the disclosed subject matter is managing a whitelist of approved URLs a shared browsing session is enabled to view. Another aspect of the disclosed subject matter is creating new shared browsing sessions directly from the browser's address bar or through any user interface. In another aspect of the disclosed subject matter each new shared browsing session can be given a name or a name can be randomly generated. An additional aspect of the disclosed subject matter is permitting shared browsing session (including all active clients) to be started on, or redirected to, a new URL or a search term (using the default search engine), directly from the browser's address bar or through any user interface. Yet another aspect of the disclosed subject matter is permitting shared browsing sessions in all major web browsers (including, but not limited to, smart phones and other web-enabled devices) without the need for additional software or plugins.

In the example of FIG, 2, the load balancing engine 202 controls communication between real-time clients (not shown) and the real-time server 204. The load balancing engine 202 can improve the efficiency with which requests or data exchanges are handled relative to a system that does not have load balancing under a set of network conditions. In a specific implementation, the load balancing engine 202 has Nginx installed on it.

In the example of FIG. 2, the real-time server engine 204 can handle real-time data exchanges from one real-time client to another. In a specific implementation, the real-time server engine 204 can handle annotations (e.g., paint, pen-tool, comments, highlighting, etc.). In a specific implementation, in operation, the real-time server engine 204 accepts connections from various transports (e.g. websocket, flashsocket, ajax long polling, ajax multipart streaming, forever-frame, jsonp polling, etc.) depending on the capabilities of browsers of the real-time clients. In a specific implementation, node.js is installed on the real-time server engine 204. In one embodiment, the real-time server engine 204 handles real-time requests on port 8080 and is responsible for streaming event data in real-time between clients and for persistently storing modifications to webpage sources (e.g. mouse clicks, movements, scrolling, hovers, session updates, annotations, chat, etc.) in the event replication datastore 206.

A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

In the example of FIG. 2, the real-time server engine 204 maintains data in the event replication datastore 206. Advantageously, the real-time server engine 204 can maintain a document data structure in the event replication datastore 206 sufficient to replicate on the server-side client-side changes to a document structure on a real-time client. The event replication datastore 206 includes a document source (cache), which the real-time server engine 204 loads into a document object model (“DOM”) and executes event handlers that were called on the real-time client. This results in the same changes on the server-side instance of the document structure in the replication datastore 206 that have happened to the real-time client's instance. Advantageously, in a specific implementation, methods or scripts in the document can be executed here in addition to event handlers. In a specific implementation, the real-time server engine 204 can modify the cache of the event replication datastore 206 without a DOM by directly modifying an event string. Once the server instance of the webpage matches the client's instance, it is stored in the event replication datastore 206 for later retrieval.

In a specific implementation, the event replication datastore 206 includes current and historic webpage structures for a session, including any annotations. This permits clients joining late to see the latest web page including annotations as well as permitting participants to revisit a webpage that was previously viewed during the session including all annotations (e.g. the stored annotated webpage could show dynamic content such as news articles, advertisements and annotations as the webpage existed when the page was viewed by the session).

The core-server 208 accepts connections passed from the load balancing engine 202. Generally, the core-server 208 responds to port 80 (client) requests and is responsible for serving webpages to the real-time clients. In a specific implementation, the core-server 208 has node.js installed on it.

The core-server 208 has logic to route requests based on the structure of the requested URL. Some examples of URLs that the core-server 208 could route in various embodiments include:

| URL | Remarks |
|---|---|
| / | loads the home page |
| /_monit | is a call from monit |
| /_loadbalancer | is a call from Amazon Web Service (“AWS”) to check |
| | status of core instance |
| /search | comes from search bar (either the home page or toolbar) |
| /share/* | will get loaded into an iframe |
| /* | will load parent frame and pass remaining string to |
| | “/share” in an iframe |

In the example of FIG. 2, the resource server 210 can be implemented as a proxy to download a requested webpage or other content from a web content server (not shown). The resource server 210 can also have some basic scraping ability of CSS and js documents to optimize their display on a third party domain (e.g. displaying “youtube.com”). In one embodiment, the resource server 210 handles port 9000 requests and is responsible for serving web content server static content (e.g. assets) and making modifications to the content's values. In a specific implementation, the resource server 210 has node.js installed on it.

In the example of FIG. 2, the in-memory data server 212 can be implemented as a key-value store or data structure server that keeps data in memory for fast access and is able to persist data to a file system. The data can also be persisted to a relational database and loaded into memory again when needed to be accessed quickly. In one embodiment, the in-memory data server 212 has Redis installed.

In the example of FIG. 2, the web client engine 214 makes calls and requests to the web content server to retrieve a requested URL. The web client engine 214 passes retrieved webpages to the core-server 208 for further handling.

The scraping engine 216 modifies a retrieved webpage's source code to ensure its proper display and behavior on an external domain. Additionally, the scraping engine 216 modifies source code to the extent necessary to enable co-navigation and to embed proprietary code that enables changes to a document structure (e.g. annotations) and other features as well as a user interface for collaborating on and controlling the webpage.

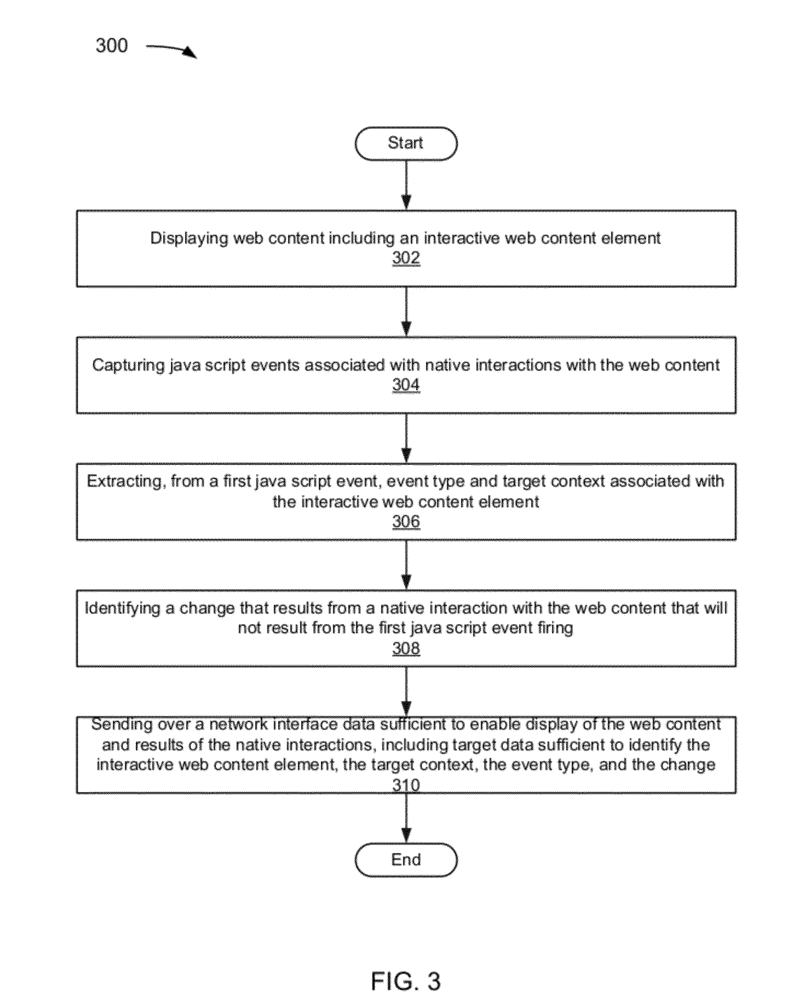

FIG. 3 depicts a flowchart 300 of an example of a method for sharing interactions to web content. The example of FIG. 3 is intended to illustrate how a first shared session client interacting with content can provide data sufficient to enable a second shared session client to observe the results of the interaction. The flowchart 300, and other flowcharts in this paper, are illustrated as serially arranged modules and decision points, but it should be noted that the flowcharts could be reordered or arranged for parallel execution of certain modules.

In the example of FIG. 3, the flowchart 300 starts at module 302 with displaying web content including an interactive web content element. Content can include content elements, including interactive elements. An interactive element can be defined as an element that has an event listener bound to it. Thus, an interactive web content element “listens” for interactions with the web content element to which an event listener is bound. Elements with which an event listener is not bound are not interactive web content elements. It may be noted, however, that in a specific implementation, certain interactive web content elements are protected with permissions and in that specific implementation, described in more detail later, a user can interact with an interactive web content element and be denied permission to make a change that would normally be appropriate given the interaction. Thus, interaction is possible with interactive web content elements even if permission is not granted. A user can typically interact with interactive web content elements through, e.g., a web browser. For other applicable content, a known or convenient content interface can be used.

In the example of FIG. 3, the flowchart 300 continues to module 304 with capturing all java script events associated with native interactions with the web content. Applicable known or convenient events can be captured, such as change (e.g., to a drop down form, radio button, check box, etc.), mouse move, mouse over, mouse out, mouse down, mouse up, click, double-click, key down, key up, key press, and scroll. In a specific implementation, the events include focus and blur.

In the example of FIG. 3, the flowchart 300 continues to module 306 with extracting, from a first java script event of the java script events, event type and target context associated with the interactive web content element. Event type identifies an event as change, mouse move, etc. Target context includes data, such as a mouse position, key event (e.g., Left-ALT is held down when the event occurs), or other environmental condition or variable extant when an event is captured, that can be sent in association with the event type.

In the example of FIG. 3, the flowchart 300 continues to module 308 with identifying a change that results from a native interaction of the native interactions with the web content that will not result from the first java script event firing. For example, a native interaction to select a drop-down menu and highlight an option in the drop-down menu may not result in the highlight occurring if the java script events are dutifully fired. The change augments the java script events that are streamed from a first shared session client device to enable a second shared session client device to display interactions with shared content as they occurred on the first shared session client device.

In the example of FIG. 3, the flowchart 300 ends at module 310 with sending over a network interface data sufficient to enable display of the web content and results of the native interactions, including target data sufficient to identify the interactive web content element, the target context, the event type, and the change. Thus, a first shared session client device sends data sufficient to enable a second shard client device to display interactions with shared content as they occurred on the first shared session client device.

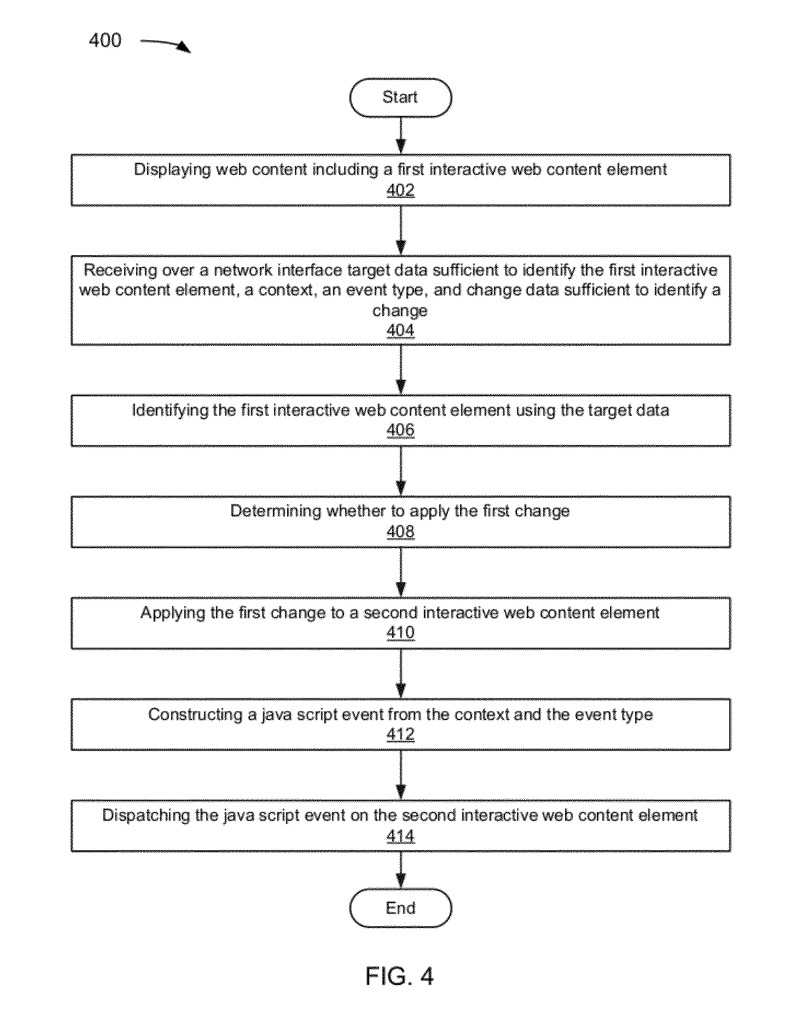

FIG. 4 depicts a flowchart 400 of an example of a method for receiving shared interactions to web content. The example of FIG. 4 is intended to illustrate how a second shared session client can receive data sufficient to enable a second shared session client to observe results of interaction with shared content at a first shared session client. In the example of FIG. 4, the flowchart 400 starts at module 402 with displaying web content including a first interactive web content element.

In the example of FIG. 4, the flowchart 400 continues to module 404 with receiving over a network interface target data sufficient to identify the first interactive web content element, a context, an event type, and change data sufficient to identify a first change. The target data, context, event type, and change are described by way of example above with reference to FIG. 3.

In the example of FIG. 4, the flowchart 400 continues to module 406 with identifying the first interactive web content element using the target data. Because the target data includes data sufficient to identify the first interactive web content element, it is possible to identify the first interactive web content element using the target data.

In the example of FIG. 4, the flowchart 400 continues to module 408 with determining whether to apply the first change. The determination whether to apply the first change can depend upon a number of variables, such as if the first change is necessary, differences between the browsers of the first shared session client and the second shared session client (e.g., one might use Firefox and one might use Internet Explorer, which have differing native interaction results).

In the example of FIG. 4, the flowchart 400 continues to module 410 with applying the first change to a second interactive web content element. It should be noted that the first interactive web content element and the second interactive web content element may or may not be the same element. This is because interaction with an interactive element can cause a change to the interactive element or with some other interactive element.

In the example of FIG. 4, the flowchart 400 continues to module 412 with constructing a java script event from the context and the event type. After the change has been applied, which ensures that changes not captured in java script are made, the java script includes all other relevant changes. By capturing context and event type, the event can be fired on the second shared session client in such a way that the results of interaction on the first shared client are displayed.

In the example of FIG. 4, the flowchart 400 ends at module 414 with dispatching the java script event on the second interactive web content element. It should be noted that although the results of interaction with content at the first shared session client are captured an displayed on the second shared session client, the display can be slightly different. For example, the first shared session client could display a cursor in black, while the second shared session client displays the cursor of the first shared session client in blue and the second shared session client's own cursor in black.

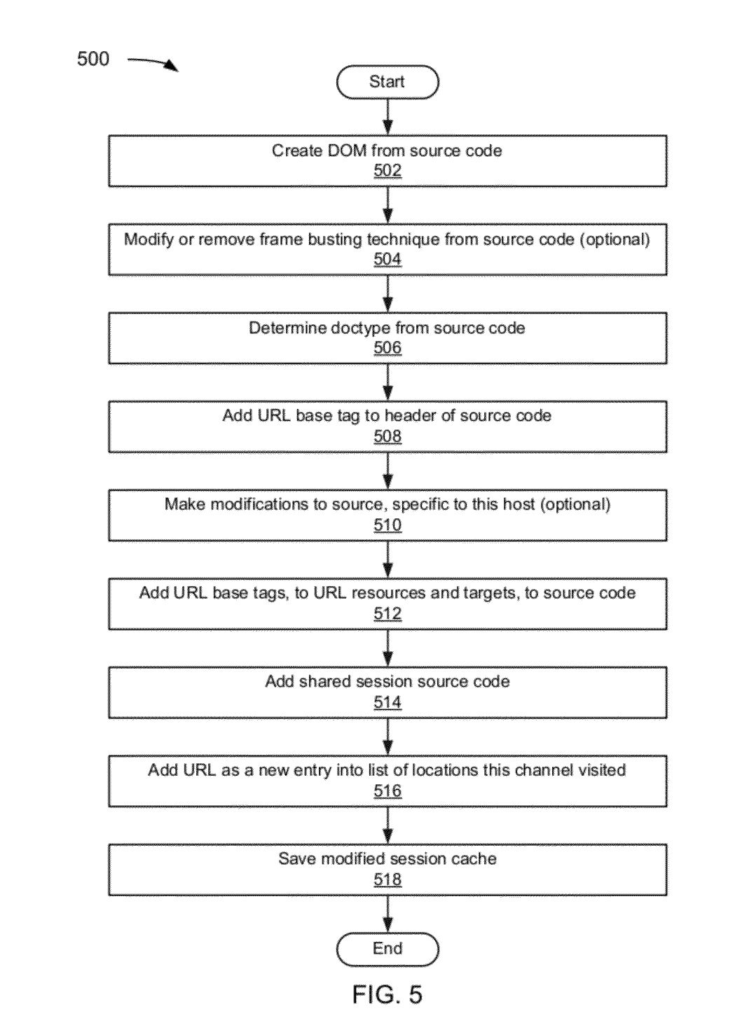

FIG. 5 depicts a flowchart 500 of an example of a method for modifying content for compatibility in a shared content session. FIG. 5 is intended to illustrate an example of how to modify source code of a retrieved webpage.

In the example of FIG. 5, the flowchart 500 starts at module 502 with creating a document object model (DOM). The DOM can be created by, for example, a shared content synchronization server engine (see, e.g., FIG. 1, shared content synchronization server engine 114). The DOM can be created by a scraping engine (see, e.g., FIG. 2, scraping engine 216), which, in a specific implementation, is included in the shared content synchronization server engine.

In the example of FIG. 5, the flowchart 500 continues to module 504 with modifying or removing frame busting technique from source code. “Frame busting” code is code that is intended to prevent the loading of a webpage into another party's framed webpage. Module 504 is optional because not all content will include frame busting techniques, but is believed to be desirable because at least some currently-available web content includes content incorporating frame busting techniques. Thus, in a specific implementation, the source code of the DOM is searched for signs of “frame busting” for modification or removal. If there is frame busting code, the source code is modified to remove the offending code. It is important to note that frames are not required, but if frames are employed, module 504 helps ensure the content is properly displayed.

In the example of FIG. 5, the flowchart 500 continues to module 506 with determining document type from the source code.

In the example of FIG. 5, the flowchart 500 continues to module 508 with adding URL base tag to header of source code.

In the example of FIG. 5, the flowchart 500 continues to module 510 with making modifications to source, specific to this host. The URL can be checked for exceptions such as replacing embedded flash content that does not have permission to be accessed by the document domain with a version that is friendly to external embedding. As a means of example, and not of limitation, this is helpful for videos in webpages from youtube.com. These types of links are replaced with the cross domain friendly embed tags that are made public. Module 510 is optional because not all content will include exceptions, but it is believed to be desirable because at least some currently-available web content includes content incorporating exceptions. If there is a need for one or more exceptions, the source code is modified to address those exceptions for that particular host.

In the example of FIG. 5, the flowchart 500 continues to module 512 with adding URL base tags, to URL resources and targets, to source code. For example, www.slashjoin.com could be appended to the front of every link and/or form. In another example, webpages or websites that required their resources to be proxied, could have the tags script, style, image, etc., prefixed with by a shared content synchronization server engine (e.g. slashjoin.com:9000/). The webpages or websites could have the tags, etc. prefixed by a resource server (see, e.g., FIG. 2, resource server 210).

In the example of FIG. 5, the flowchart 500 continues to module 5014 with adding shared session source code. The shared session source code can include proprietary code of a shared session server. In a specific implementation, the shared session source code changes document structure (e.g. additional commenting, collaboration, and editing features), the user interface, and/or the scripts. The changes are used by shared session clients and a real-time shared session server engine (see, e.g., FIG. 1, real-time shared session server engine 116; see also, FIG. 2, real-time server engine 204) to provide functionality in a shared session.

In the example of FIG. 5, the flowchart 500 continues to module 516 with adding URL as a new entry into a list of locations this channel visited. This enables clients to retrace steps in a co-navigation session.

In the example of FIG. 5, the flowchart 500 ends at module 518 with saving the modified session cache. For example, the modified session cache can be added to a datastore on an in-memory server (see, e.g., FIG. 2, in-memory server .212).

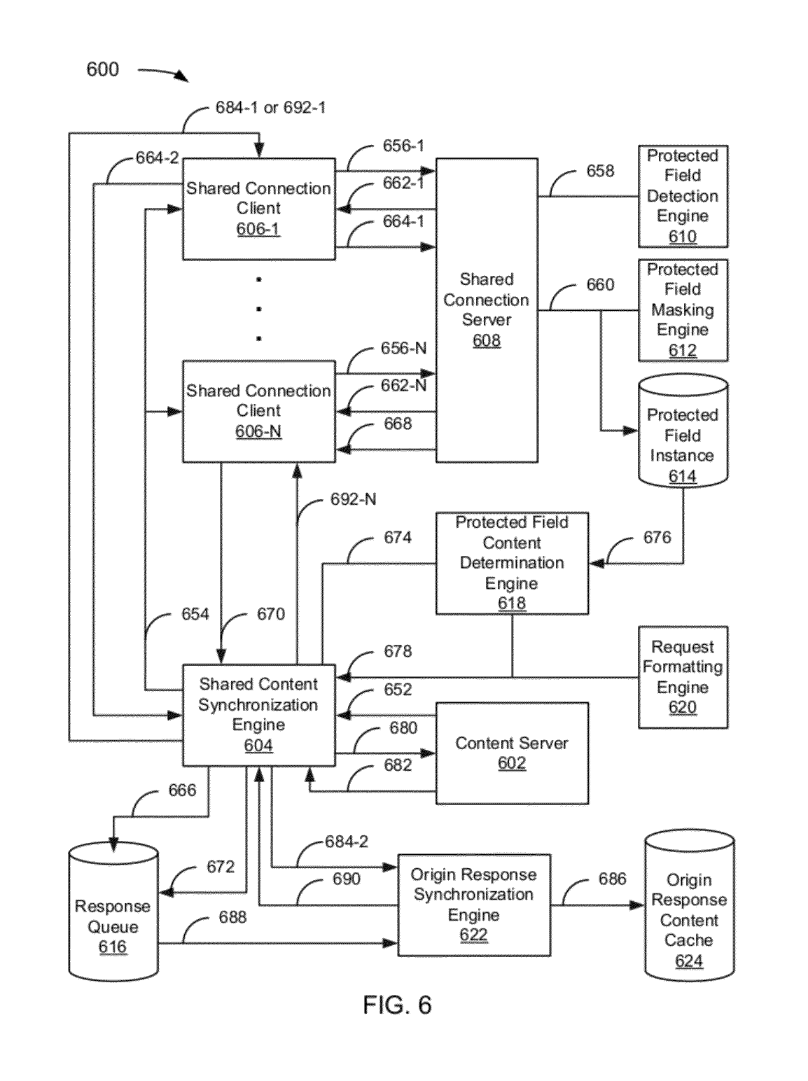

Some examples of interactions captured at a first shared session client (see, e.g., FIGS. 1 and 3) and recreated at a second shared session client (see, e.g., FIGS. 1 and 4) are described with reference to FIGS. 6-16.

FIG. 6 depicts an example of a system 600 for masking protected fields in a shared content session. The system 600 includes a content server 602, a shared content synchronization engine 604, shared connection clients 606-1 to 606-N (collectively, shared connection clients 606), a shared connection server 608, a protected field detection engine 610, a protected field masking engine 612, a protected field instance datastore 614, a response queue datastore 616, a protected field content determination engine 618, a request formatting engine 620, an origin response synchronization engine 622, and an origin response content cache datastore 624.

In the example of FIG. 6, in operation, the shared content synchronization engine 604 receives content (652) from the content server 602. The shared content synchronization engine 604 can alternatively, depending upon perspective, act as a content client of the content server 602 and as a proxy content server for the shared connection clients 606. In a specific implementation, the shared content synchronization engine 604 appears to the content server 602 to be a content client (thus, the content server 602 may or may not be aware that the shared content synchronization engine 604 also acts as a proxy to the shared connection clients 606). In a specific implementation, the content server 602 is controlled by an entity that is different than the entity controlling the shared content synchronization engine 604 and, accordingly, in such an implementation the content server 602 can alternatively be referred to as a third party content server.

In the example of FIG. 6, in operation, the shared content synchronization engine 604 sends the content (654) to the shared connection clients 606. In order to be part of a shared content session, the shared connection clients 606 must have joined the shared content session. Because all of the shared connection clients 806 are participants in the shared content session, the shared content synchronization engine 604 knows to send the content to each of the shared connection clients 606.

In the example of FIG. 6, in operation, the shared connection server 608 receives respective event streams (656) from the shared connection clients 606. The event streams include sufficient data to depict the content displayed on the shared connection clients 606 and results of interactions with the content, which is described in more detail elsewhere in this paper. In a specific implementation, the shared connection clients 606 are controlled by entities other than the entity that controls the shared connection server 608.

In the example of FIG. 6, in operation, the protected field detection engine 610 identifies protected fields (658) in content. Protected fields are a subset of interactive content elements. Depending upon the implementation, the shared content synchronization engine 604 can modify content source code to identify protected fields explicitly, making it relatively trivial for the protected field detection engine 610 to identify the protected fields, and/or the protected field detection engine 610 can identify protected fields by observing their handles (e.g., password).

In the example of FIG. 6, in operation, the protected field masking engine 612 makes data (660) input into the protected field unintelligible. Because the contents of the protected field presumably are important (e.g., a password field, if entered correctly followed by ‘return’, can cause the content server 602 or some other server to provide new content), the data input into the protected field is stored in the protected field instance 614 prior to it being masked or otherwise rendered unintelligible.

In the example of FIG. 6, in operation, the shared connection server 608 sends masked protected field data back to the shared connection clients 606. It should be noted that in some cases it may be unnecessary to send the masked protected field data to certain ones of the shared connection clients 606. For example, if a user of the shared connection client 606-1 enters a value in a protected field, the shared connection client 606-1 does not need to receive the masked value (662-1). In some cases, certain portions of a protected field might be provided back to different ones of the shared connection clients 606. For example, a cooperative password that requires multiple users to enter a portion of the password can result in only portions of the masked value being returned to various ones of the shared connection clients 606.

In the example of FIG. 6, in operation, the shared connection server receives a submit event 664-1. The shared connection client 606-1 is illustrated as providing the submit event 664-1 for illustrative purposes. The shared connection client 806-1 can send the submit event (664-1) as part of the event stream (656-1) and may treat the submit event (664-1) no differently than any other event for the purpose of reporting to the shared connection server 608. In addition, the shared connection server 608 may or may not be aware that the event resulted in a submit request, and could simply provide the submit request back to other shared connection clients 606 without recognizing a submit event occurred. Triggering the submit event has another effect: The shared content synchronization engine 604 receives a submit request (664-2) when the submit event is triggered. Thus, the shared connection client 606-1 sends both the submit event (664-1) as part of the stream of events (656-1) reported to the shared connection server 608 and the submit request (664-2) in the direction of the content server (typically) in order to request other content.

In the example of FIG. 6, in operation, the shared content synchronization engine 604 stores the submit request (666) in the response queue datastore 616. It may be noted that the shared content synchronization engine 604 may or may not know that the shared connection client 606-1 has provided the proper request (e.g., the protected fields include the intended value), but there is not necessarily a guarantee that submit request (666) from the appropriate one of the shared connection clients 606 is actually received before requests from another one of the shared connection clients 606.

In the example of FIG. 6, in operation, the shared connection server 608 reports the submit event (668) to, e.g., the shared connection client 606-N. The shared connection server 608 may or may not be aware that the submit event (668) is a submit event, and could treat the submit event (668) the same as other events that are reported to the shared connection client 606-N to enable the shared connection client 606-N to display the content displayed at the shared connection client 606-1, including results of interaction with the content.

In the example of FIG. 6, in operation, when the shared connection client 606-N receives the submit event (668), that triggers a submit request (670). The shared content synchronization engine 604 receives the submit request (670) before or after the submit request (666) of the shared connection client 606-1 (the submit request originator). There is no guarantee that the submit request (666) will be received before the submit request (670) and submit requests from other ones of the shared connection clients 606. Depending upon the implementation, it may be the case that none of the requests include the proper value in the protected field (which means the request must be formatted before sending to the content server 602). Depending upon the implementation, it may be the case that only the submit request originator provides the proper value in the protected field.

In the example of FIG. 6, in operation, the protected field content determination engine 618 determines the proper value for the protected field (674). This can be accomplished by consulting the protected field instance datastore 614 to retrieve the proper value (676). Alternatively, the proper value could be in the submit request (664-2) of the original submit request generator, and the protected field content determination engine 618 can identify the field name (i.e., the correct field) and identify the original submit request generator (i.e., the correct user).

In the example of FIG. 6, in operation, the request formatting engine 620 formats a request (678) that is to be submitted to the content server 602 to include the proper values. The shared content synchronization engine 604, in its role as a content client, sends a request (680) to the content server 602 and, receives a response (682). If the shared content synchronization engine 604 knows the identity of the request originator, the shared content synchronization engine 604 may or may not, depending upon the implementation, send the response (684-1) directly to the shared content client 606-1 and also provide the response (684-2) to the origin response synchronization engine 622. Alternatively, the shared content synchronization engine 604 can provide the response (684-2) to the origin response synchronization engine 622 and not send the response (684-1) to the shared connection client 606-1.

In the example of FIG. 6, in operation, the origin response synchronization engine 622 ensures that the response (684-2) from the content server 602 is properly distributed to the shared connection clients 606. To aid in the distribution process, the origin response synchronization server engine caches (686) the response in the origin response content cache 624. The origin response synchronization engine 622 consults the response queue datastore 616 to determine (688) the shared connection clients 606 awaiting a response. The origin response synchronization engine 622 provides the responses (690), with modifications as appropriate, to the shared content synchronization server, which sends the responses (692) to respective ones of the shared connection clients 606.

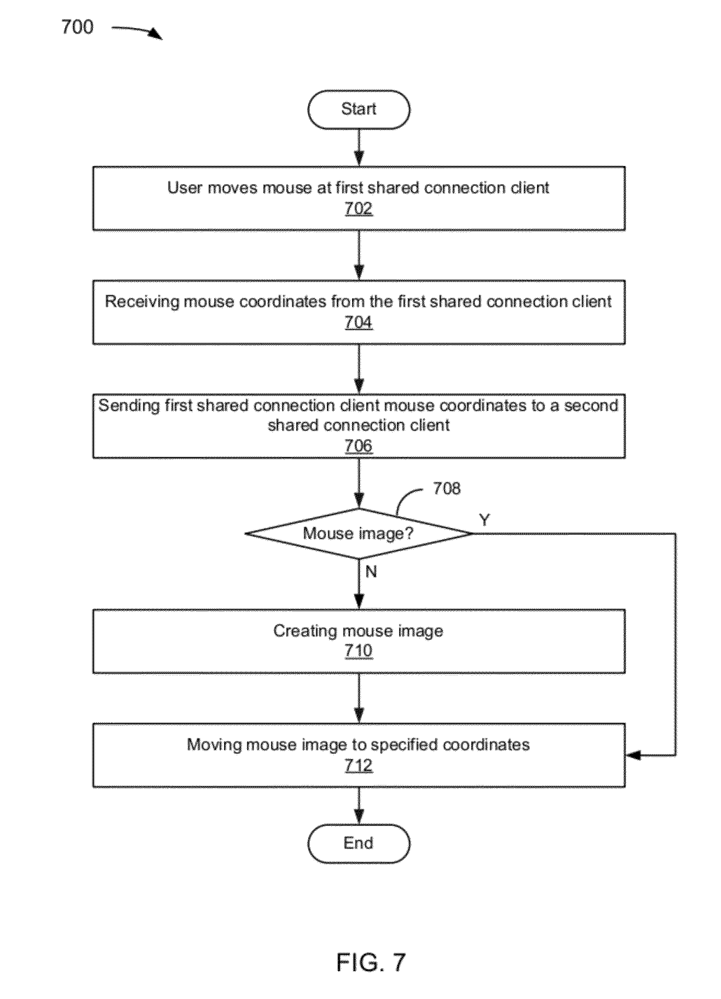

FIG. 7 depicts a flowchart 700 of an example of a method for streaming real-time mouse position. FIG. 7 is intended to illustrate how when a first shared connection client user moves a mouse, the first shared connection client provides data sufficient for a second shared connection client to display the mouse movement on the second shared connection client. In the example of FIG. 7, the flowchart 700 starts at module 702 with user moving mouse at first shared connection client.

In the example of FIG. 7, the flowchart 700 continues to module 704 with receiving mouse coordinates from the first shared connection client. The mouse coordinates can be transmitted by, e.g., a web browser at the client to a shared connection server. In a specific implementation, the mouse coordinates can be received in an event stream along with other events.

In the example of FIG. 7, the flowchart 700 continues to module 706 with sending first shared connection mouse coordinates to a second shared connection client. The second shared connection client is representative (the mouse coordinates can be sent to all of the shared connection clients on the same channel).

In the example of FIG. 7, the flowchart 700 continues to decision point 708 with determining whether a mouse image has been created. If it is determined that a mouse image has not been created (708-N), then the flowchart 700 continues to module 710 with creating a mouse image. The mouse image can be created at a shared connection server and sent to the second shared connection client. The mouse cursor can be formatted to be the same as the mouse cursor at the first shared connection client, or the mouse cursor can be formatted such that it is clear upon visually inspecting the mouse cursor in a display that the mouse cursor is that of the first shared connection client. For example, the cursor can have an identifier hovering near it, the cursor can be of a color that makes it identifiable as that of the first shared connection client, etc. Where there are many shared connection clients, it may be desirable to reduce the time a mouse cursor hovers (to reduce the number of mouse cursors on the screen at one time), not display the mouse cursors of certain of the shared connection clients, display only the latest mouse cursor, etc. Alternatively, the second shared connection client can receive the mouse coordinates and create the mouse image at the client.

In the example of FIG. 7, the flowchart 700 continues to module 712 with moving mouse image to specified coordinates. Typically, the mouse will be moved at the client in response to receiving the event triggers from the shared connection server, though the mouse movement could alternatively be handled at the shared connection server.

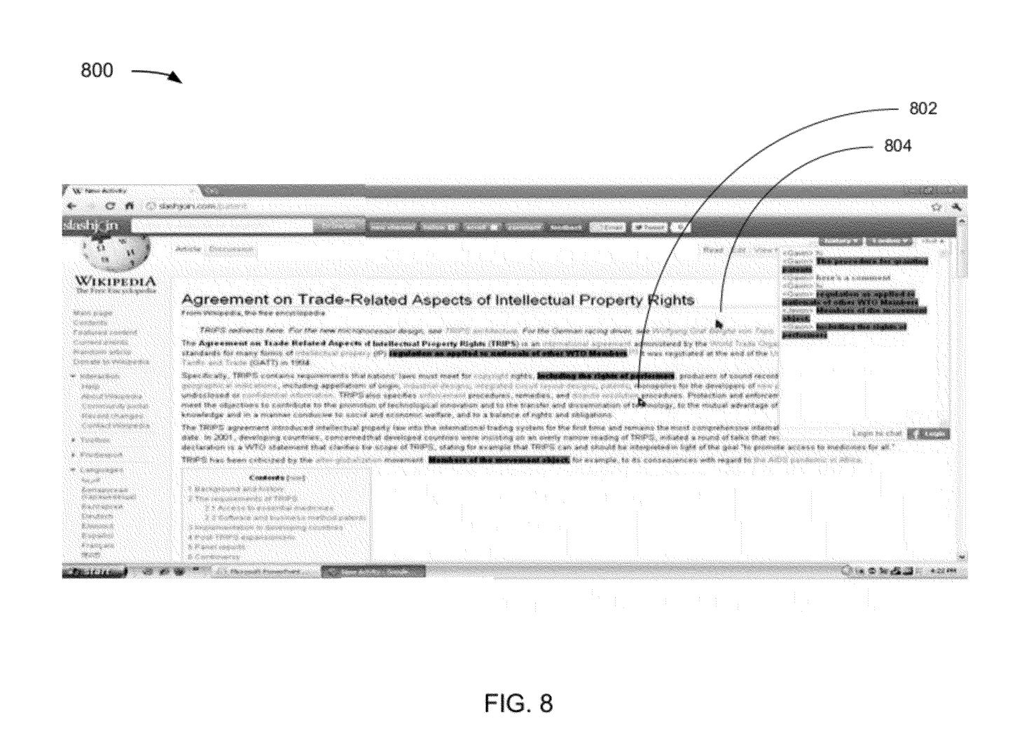

FIG. 8 depicts a screenshot 800 of an example of a web page with a first shared connection client mouse cursor 802 and a second (local) shared connection client mouse cursor 804. The screenshot 800 also shows a shared connection chat feature in the upper right corner and several passages from the webpage have been highlighted. The screenshot 800 does not represent merely a video transmitted from one machine to another, but an actual webpage displayed in all of the client's web browsers who are participating in the session/channel. All of the shared connection clients participating in the session/channel can interact with the webpage through their mouse and/or keyboard including clicking the links, typing, highlighting, commenting, or a host of other collaboration, annotation, interaction, and/or document source changes. Any of these changes and/or interactions are then provided to the other clients in the session/channel. Note also the history feature above the chat box which allows the participants of the channel to return to previously viewed pages. Upon return to the previously viewed pages, a user would see all of the previous changes to that webpage. Also, note the “menu” bar at the top of the webpage which can be used to enable additional functionality. An additional feature is that all of the above are performed in near real-time (e.g. under normal circumstances, in under a second).

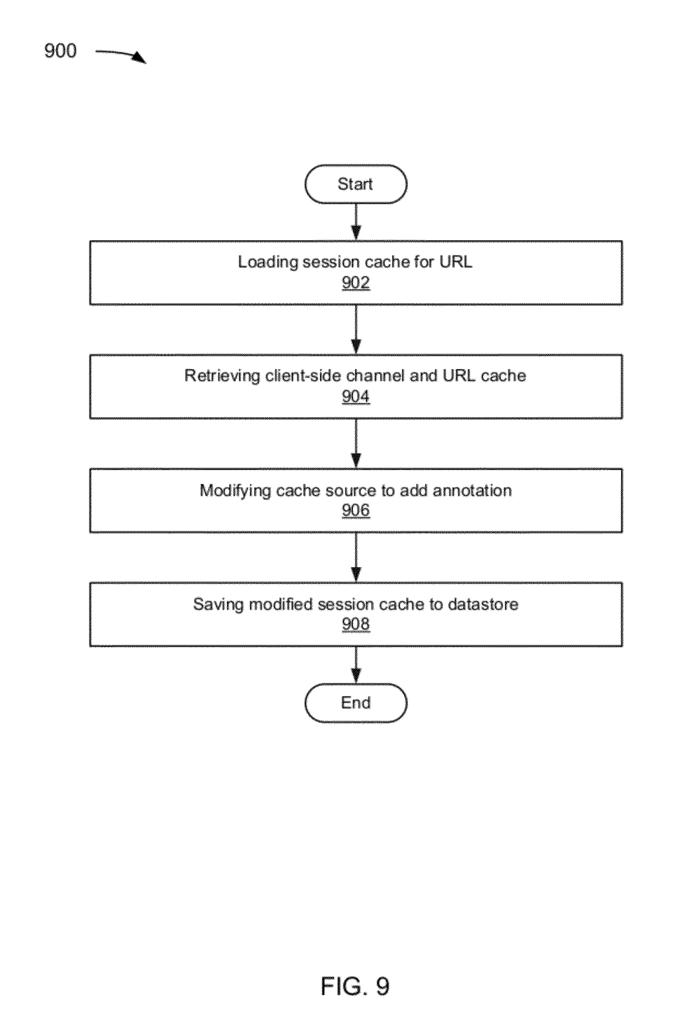

FIG. 9 depicts a flowchart 900 of an example of a method for modifying source code of a webpage to add an annotation. In the example of FIG. 9, the flowchart 900 starts at module 902 with loading session cache for URL. A shared connection server loads the session cache with a requested URL. In the example of FIG. 9, the flowchart 900 continues to module 904 with retrieving client-side channel and URL cache. The shared connection server retrieves the client-side channel and URL cache. In the example of FIG. 9, the flowchart 900 continues to module 906 with modifying cache source to add annotation. In the example of FIG. 9, the flowchart 900 continues to module 908 with saving modified session cache to datastore, such as at an in-memory server.

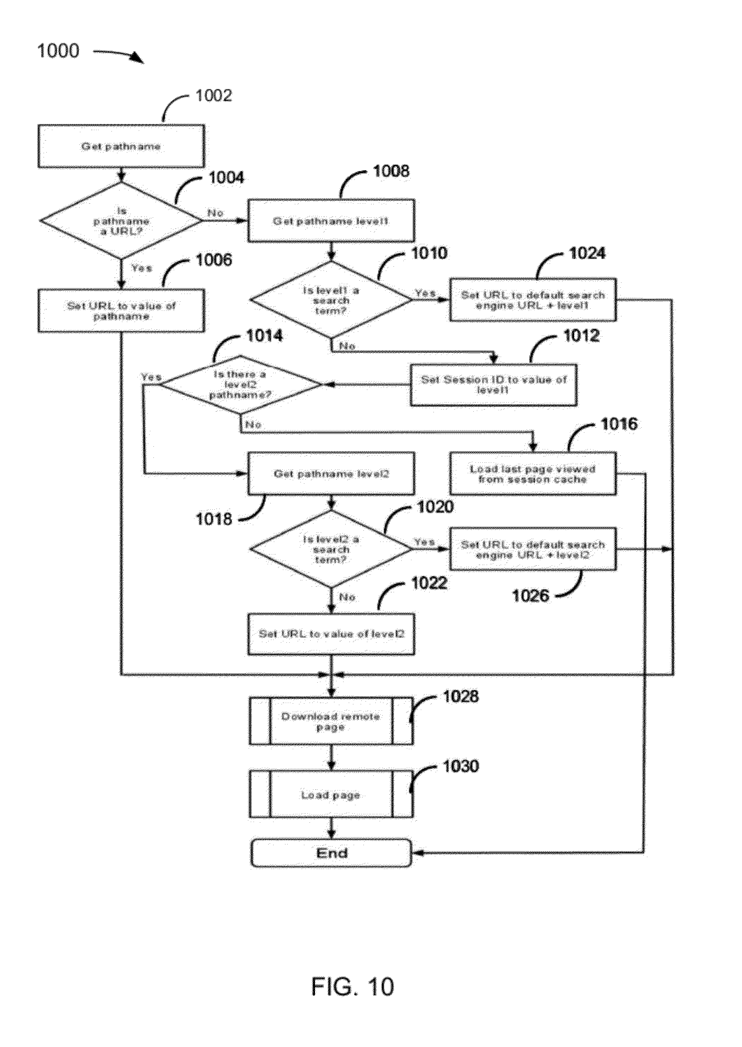

FIG. 10 depicts a flowchart of an example of a method for determining session ID and remote URL from a requested URL. This figure is best understood with an example, making reference to the elements depicted in FIG. 2. At module 1002 the pathname is retrieved by the core-server 208. In this example, the pathname is “slashjoin.com/gavin/gavinuhma.com”. At decision point 1004, the coreserver 208 determines if the pathname is a URL. If the pathname was a URL, the internal URL is set to the pathname at module 1006; however, in this example the pathname is not a URL but a compound pathname containing both a session ID (also called a channel throughout this disclosure); therefore, at module 1008, the core-server 208 begins to parse the pathname by identifying the level-1 pathname. In this example the level-1 pathname is “gavin”. At decision point 1010, the core-server 208 determines whether the level-1 pathname is a search term which is determined by the existence of characters that are not allowed in the session ID (e.g. encoded characters, etc.) or by the lack of the level-1 pathname existing as a session ID in the data store. Because the level-1 pathname is not a search term, the session ID is set to the level-1 pathname at module 1012. Therefore, in this example, the session ID is “gavin”. Next, the core-server 208 parses the remainder of the pathname to identify the level-2 pathname at decision point 1014. If level-2 does not exist the session cache is loaded for the last page that was viewed on the session at module 1016. At module 1018 the core-server 208 gets the level-2 pathname. At decision point 1020 the core server 208 determines if the level-2 pathname is a search term. If not, the internal URL is set to the level-2 pathname at module 1022. Therefore, in this example, the internal URL is set to “gavinuhma.com”. However, if the level-1 pathname or the level-2 pathname were search terms, the internal URL would have been set to the default search engine URL with the addition of the level-1 or level-2 pathname, at modules 1024 and 1026, respectively. After modules 1022, 1024, or 1026, the web client engine 214 downloads the remote page at module 1028 from a content server using the internal URL. The core-server 208 also loads the downloaded remote page into a new html page including an iframe at module 1030. Continuing the above example, the iframe source would be set to “http://slashjoin.com/share/gavin/gavinuhma.com” thereby prefixing the “/share” string so that the server will know how to handle the page when the iframe is loaded).

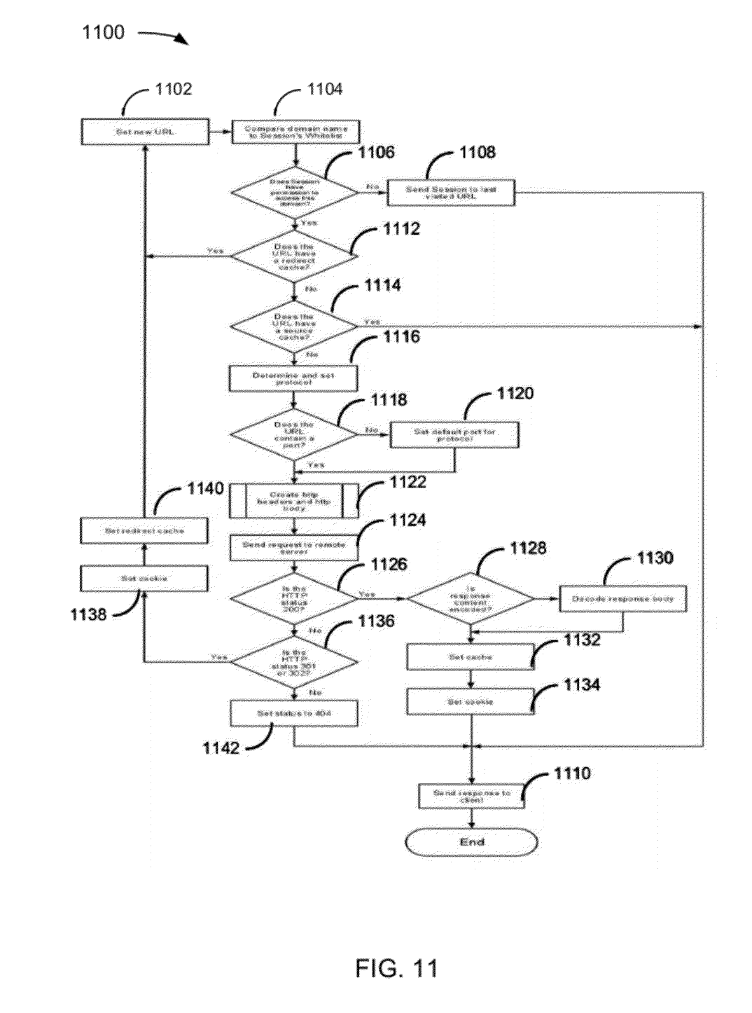

FIG. 11 depicts a flowchart 1100 of an example of a method for downloading a remote page. At module 1102 a new internal URL is set. At module 1104, the web client engine 214 verifies that the domain name contained in the internal URL is on the session's whitelist. If it is determined at decision point 1106 that the domain name is not on the session's whitelist, the session is sent to the last authorized URL at module 1108 and the response is sent to the client 1110. However, if the domain name is on the whitelist, the web client engine 214 determines at decision point 1112 whether the webpage corresponding to the internal URL has a redirect cache corresponding to the URL in the data store. If there is a redirect cache, the redirected URL is set as the internal URL at module 1102 and the flowchart 1100 continues as described previously. However, if there is not a redirect cache, the web client engine 214 determines at decision point 1114 whether the webpage has a source cache corresponding to the URL in the data store. If there is a source cache, at module 1110 the response is sent to the client. However, if there is not a source cache, the protocol is determined and set at module 1116. Next, the web client engine 214 identifies if there is a port address contained in the internal URL at decision point 1118. If not, the default port is set for the protocol identified at module 1120. Regardless, the http headers and HTTP body are created at module 1122 and the request is sent to the remote server at module 1124 by the web client engine 214.

The web client engine 214 reads the HTTP status to determine if the request was successful or there was an error at module 1126. If the request was successful, the HTTP status should be 200 and the web client engine 214 evaluates whether the response content is encoded at module 1128. If the response content is encoded, the web client engine 214 decodes the response body at module 1130. Regardless, the source cache is set at module 1132 and any cookie at module 1134. The cookie, if any, is retrieved from the content server and stored in the datastore which links the cookie to the session. This permits all of the cookies for each session to be tracked and transmitted as necessary. The cookies are duplicated and sent in the responses to each of the clients. As a means of example, and not of limitation, this permits everyone on a channel to share the same shopping cart and/or share the same login to a website. The cookie and the body of the page (e.g. the source code) are cached on the data store. Finally the response is sent to the client at module 1110.

Returning now to module 1126, if the HTTP status is not 200, the web client engine 214 checks if the HTTP status is 301 or 302 at decision point 1136 (both indicating the webpage has moved). If the HTTP status is 301 or 302, a cookie is set at module 1138, the redirect cache is set to indicate the URL of the moved webpage at module 1140, and the process starts over at module 1102. The redirect cache is set to avoid making another request to a content server that will only return the same redirect and consequently improves performance. However, if the HTTP status is not 301 or 302, the status is set to 404 (indicating the desired webpage was not found) at module 1142 and the response is sent to the client at module 1110. Although only certain status codes are discussed, one skilled in the art, with the assistance of this disclosure, could employ the teachings to handle other status codes in addition to the ones specifically set forth herein.

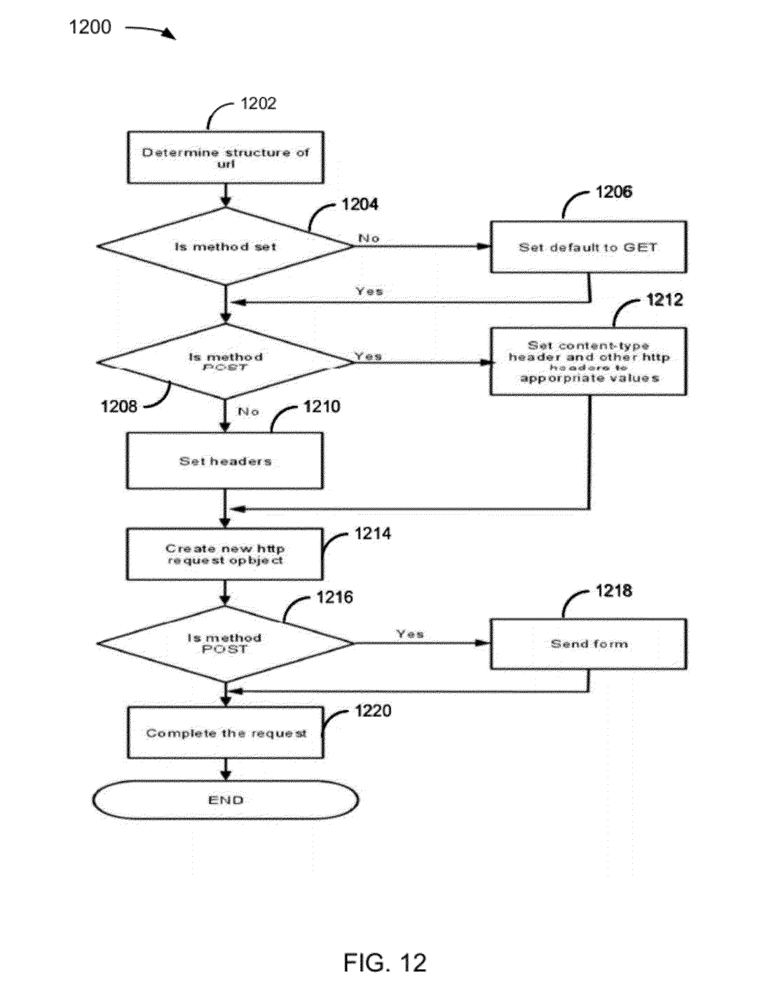

FIG. 12 depicts a flowchart 1200 of an example of a method for deriving HTTP headers from a URL and HTTP method. At module 1202 the structure of the URL is determined by the core-server 208. The core-server 208 evaluates whether the method (e.g. POST or GET) is set at decision point 1204. If the method is not set, the default method is set to GET at module 1206. After module 1206 or if the method is set, the core-server 208 determines if the method is POST at decision point 1208. If not, the headers are set at module 1210. It is important to note that the headers are not simply forwarded from the client's original connection. If the method was POST at decision point 1208, the content-type and other HTTP headers are set to appropriate values at module 1212. Again, it is important to note that the headers are created and not simply forwarded from the client's original connection. After the headers are set at either module 1210 or 1212, a new HTTP request object is created at module 1214. If the method is post at decision point 1216, the form is sent at module 1218. Either after the form is sent at module 1218 or the method is not POST at decision point 1216, the request is completed at module 1220. In a specific implementation, the request to download the remote webpage is called asynchronously so that the core-server 208 can continue to handle requests.

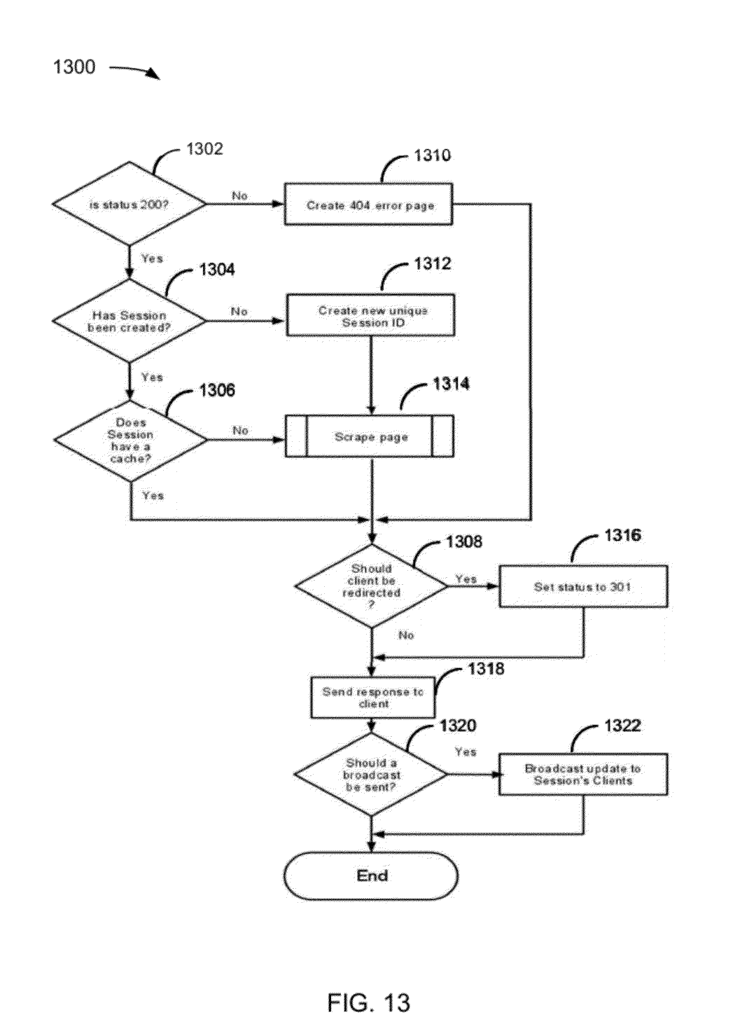

FIG. 13 depicts a flowchart 1300 of an example of a response to a shared connection client. If the HTTP status is 200 at decision point 1302, the core-server 208 verifies if a session (e.g. channel) already exists at decision point 1304. If the session already exists, the core-server 208 checks to see if there is a cache at decision point 1306 and if there is, the process proceeds to decision point Referring back to decision point 1302, if the status was not 200, the core server 208 creates a 404 error page at module 1310 and proceeds to decision point 1308. Referring back to decision point 1304, if the session has not been created, the core-server 208 creates a new unique session ID at module 1312. After module 1312, and if the session did not have a cache at decision point 1306, the retrieved webpage is scraped by the scraping engine at module 1314 and the flowchart 1300 proceeds to decision point 1308.

At decision point 1308, the core-server 208 determines if the client should be redirected. If so, the status is set to 301 at module 1316 and then, regardless of redirection, the response is sent to the client at module 1318. After the response is sent to the client at module 1318, the core-server 208 determines if a broadcast should be sent at decision point 1320. If not, the process completes. Otherwise, a broadcast is sent by the real-time server engine 204 to update the session for shared connection clients at module 1322 and the process completes. It is important to note that when responding to the client the headers and body are created by the disclosed subject matter rather than simply forwarded back.

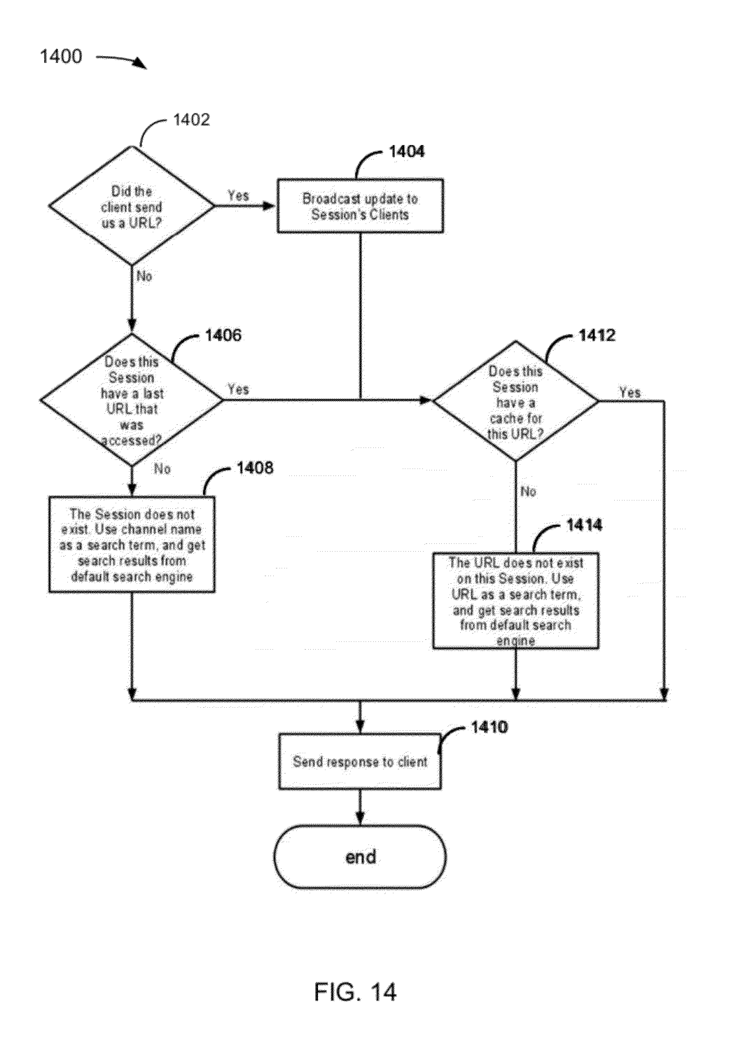

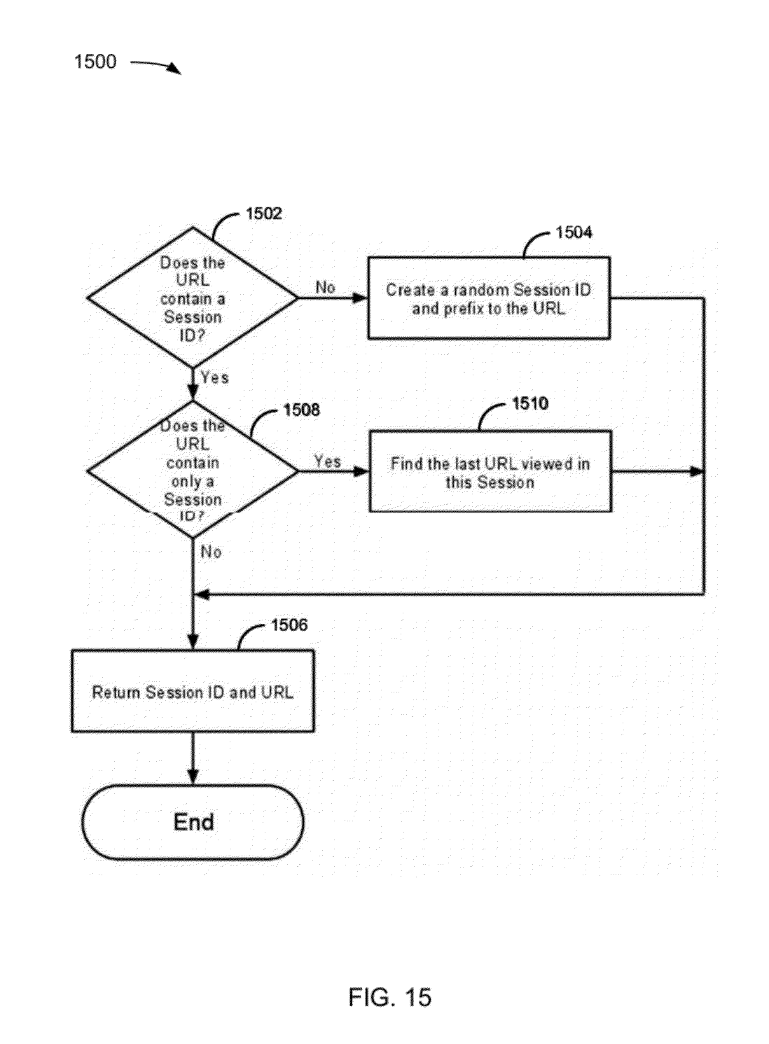

FIG. 14 depicts a flowchart 1400 of an example of a method for loading a session cache or query a default search engine. At decision point 1402 the core server 208 determines whether the client sent a URL. If a URL was sent, at module 1404 the core-server 208 tells the real-time server engine 204 to send a broadcast to the session's clients to update. If a URL was not sent at decision point 1402, the core-server 208 determines if the session has a previous URL that was visited at decision point 1406. If there was no previous URL, the core-server 208 determines the session did not exist and uses the session name (e.g. channel name) as a search term, retrieves the search results from the default search engine at module 1408, and sends the response to the client at module 1410. However, if the session did have a previously visited URL at decision point 1406 or the broadcast occurred at module 1404, the core-server 208 determines whether the session has a cache for the URL at decision point 1412. If no cache for the URL exists at decision point 1412 the URL is used as a search term, the results retrieved from the default search engine at module 1414, and the response is sent to the client at module 1410. If however, the session does have a cache form the URL at decision point 1412, then the response is sent to the client at module 1410.

FIG. 15 depicts a flowchart 1500 of an example of a method for loading a session cache or querying a default search engine. At decision point 1502, the core server 208 determines whether a requested URL contains a session ID. If there is no session ID, at module 1504 the core server 208 creates a random session ID and prefixes the random session ID to the requested URL and the flowchart 1500 proceeds to module 1506. If there was s session ID at decision point 1502, at decision point 1508 the core server 208 determines whether the requested URL contains only a session ID. If so, at module 1510, the core server 208 identifies the last URL viewed for the session ID and the flowchart 1500 proceeds to module 1506. If the URL does not contain only a session ID at decision point 1508, the session ID and the URL are returned at module 1506.

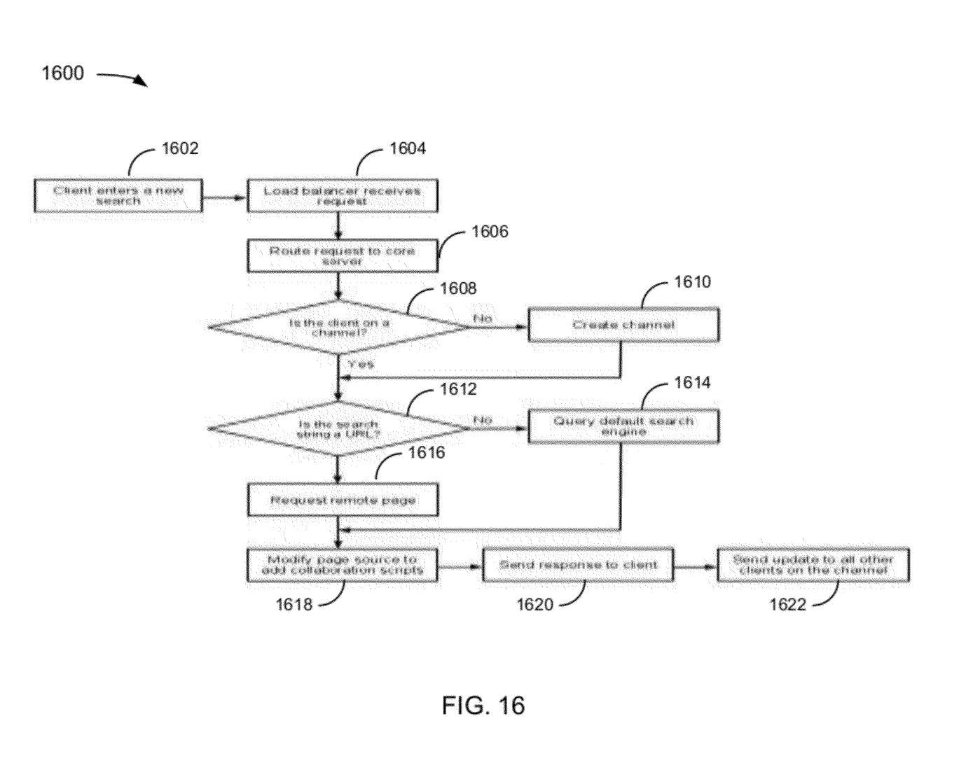

FIG. 16 depicts a flowchart 1600 of an example of requesting a new webpage. A shared connection client enters a new search at module 1602, which is received by the load balancing engine 202 at module 1604. The load balancing engine 202 routes the request to the core server 208 at module 1606. At decision point 1608, the core server 208 determines whether the shared connection client is already on a channel. If not, the core server 208 creates a channel at module 1610. At decision point 1612 the core server 208 determines if a search string was a URL. If not, the search string is processed through a default search engine at module 1614. If the search string was a URL, the web client engine 214 requests the remote page from a content server at module 1616. The web client engine 214 returns the remote page to the core server 208 which is transferred to the scraping engine 216. At module 1618, the scraping engine 216 modifies the remote page's source code to add collaboration scripts. The http response is then written to the client that initiated the request at module 1620. Finally, a request is sent to the real-time server engine 204, which instructs the real-time server engine 204 to send an update message to other shared session clients connected to the session at module 1622.

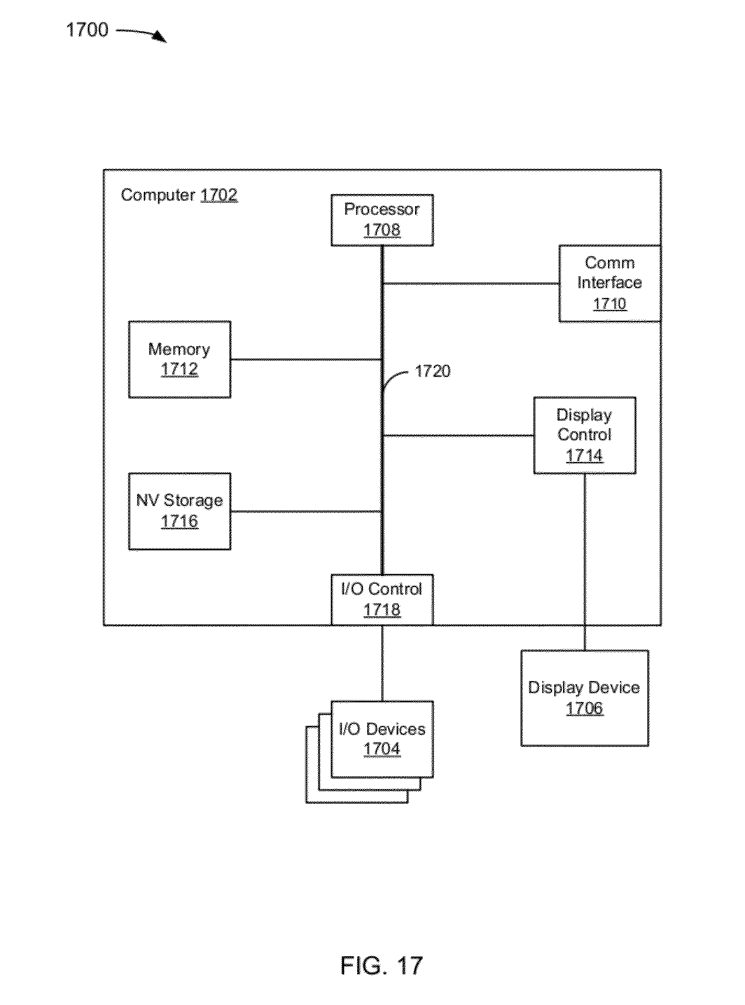

FIG. 17 depicts an example of a computer system 1700 on which techniques described in this paper can be implemented. The computer system 1700 may be a conventional computer system that can be used as a client computer system, such as a wireless client or a workstation, or a server computer system. The computer system 1700 includes a computer 1702, I/O devices 1704, and a display device 1706. The computer 1702 includes a processor 1708, a communications interface 1710, memory 1712, display controller 1714, non-volatile storage 1716, and I/O controller 1718. The computer 1702 may be coupled to or include the I/O devices 1704 and display device 1706.

The computer 1702 interfaces to external systems through the communications interface 1710, which may include a modem or network interface. It will be appreciated that the communications interface 1710 can be considered to be part of the computer system 1700 or a part of the computer 1702. The communications interface 1710 can be an analog modem, ISDN modem, cable modem, token ring interface, satellite transmission interface (e.g. “direct PC”), or other interfaces for coupling a computer system to other computer systems.

The processor 1708 may be, for example, a conventional microprocessor such as an Intel Pentium microprocessor or Motorola power PC microprocessor. The memory 1712 is coupled to the processor 1708 by a bus 1770. The memory 1712 can be Dynamic Random Access Memory (DRAM) and can also include Static RAM (SRAM). The bus 1770 couples the processor 1708 to the memory 1712, also to the non-volatile storage 1716, to the display controller 1714, and to the I/O controller 1718.

The I/O devices 1704 can include a keyboard, disk drives, printers, a scanner, and other input and output devices, including a mouse or other pointing device. The display controller 1714 may control in the conventional manner a display on the display device 1706, which can be, for example, a cathode ray tube (CRT) or liquid crystal display (LCD). The display controller 1714 and the I/O controller 1718 can be implemented with conventional well known technology.

The non-volatile storage 1716 is often a magnetic hard disk, an optical disk, or another form of storage for large amounts of data. Some of this data is often written, by a direct memory access process, into memory 1712 during execution of software in the computer 1702. One of skill in the art will immediately recognize that the terms “machine-readable medium” or “computer-readable medium” includes any type of storage device that is accessible by the processor 1708 and also encompasses a carrier wave that encodes a data signal.

The computer system 1700 is one example of many possible computer systems which have different architectures. For example, personal computers based on an Intel microprocessor often have multiple buses, one of which can be an I/O bus for the peripherals and one that directly connects the processor 1708 and the memory 1712 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1712 for execution by the processor 1708. A Web TV system, which is known in the art, is also considered to be a computer system, but it may lack some of the features shown in FIG. 17, such as certain input or output devices. A typical computer system will usually include at least a processor, memory, and a bus coupling the memory to the processor.

In addition, the computer system 1700 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1716 and causes the processor 1708 to execute the various acts required by the operating system to input and output data and to store data in memory, including storing files on the non-volatile storage 1716.

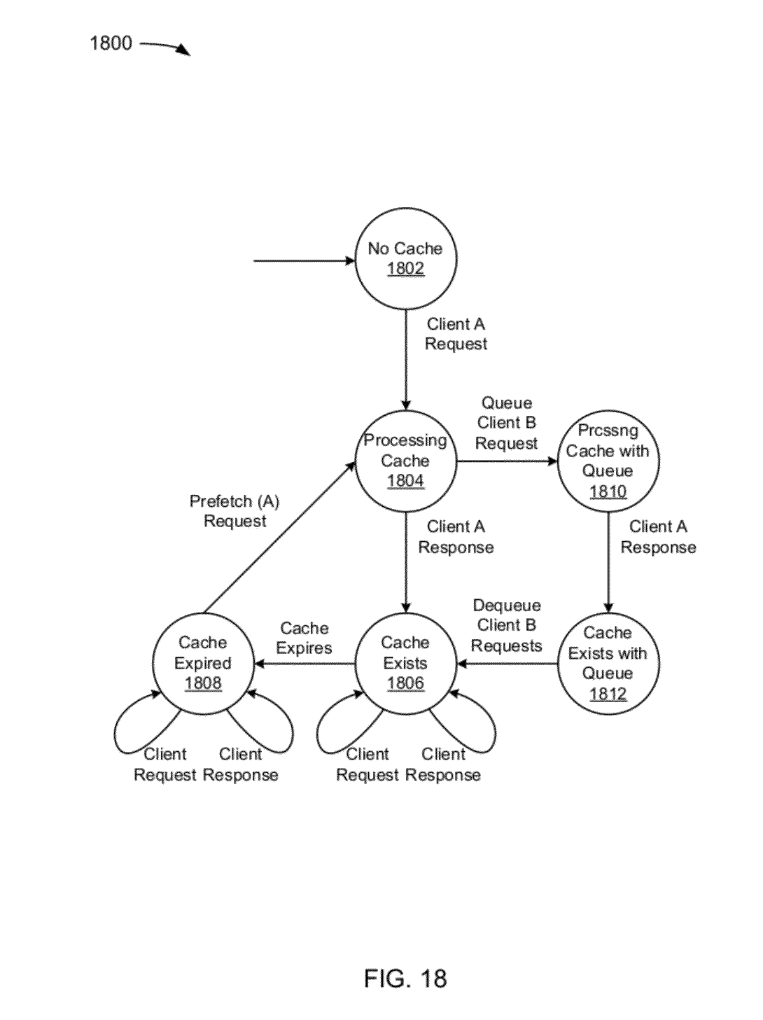

FIG. 18 depicts a state diagram 1800 of a shared content synchronization cache. The starting state of the state diagram 1800 is “no cache” 1802. Upon receiving a request from a shared session client A, the state transitions to “processing cache” 1804. The edges departing state 1804 are 1) when the cache is processed and shared session client A receives a response or 2) when a second one or more requests are received from second one or more shared session clients B. The second edge will be discussed later.

In the example of FIG. 18, the transition from state 1804 to “cache exists” 1806 is when the cache is processed and shared session client A receives a response associated with the cached content. Shared session client requests can be satisfied with the content in the cache. Accordingly, shared session client requests do not result in a state transition (the cache still exists) and responses to the shared session client requests similarly do not result in a state transition. The cache can expire, which results in a state transition.

In the example of FIG. 18, the transition from state 1806 to “cache expired” 1808 is when the cache expires. However, shared session client requests can be satisfied with the content in the expired cache. Accordingly, shared session client requests do not result in a state transition (the cache still exists even though it is expired) and responses to the shared session client requests similarly do not result in a state transition. A shared session client can make a prefetch request, which results in a state transition.

In the example of FIG. 18, the transition from state 1808 to “processing cache” 1804 is when a prefetch request is received from a shared session client. The “processing cache” state was discussed above. In order to maintain consistency with the state transition “client A response” the prefetch request is treated as a request by a shared session client A, though the shared session client A request transition from state 1802 and the shared session client A prefetch request transition from state 1808 may or may not be the same shared session client A.

In the example of FIG. 18, as was previously noted, the transition from state 1804 to “processing cache with queue” 1810 is when one or more shared session client B requests are queued. It is undesirable for the cache to be processed for a shared session client B while the cache is being processed for a shared session client A. Cache processing can be implemented as a first-come-first-served process that results in enqueueing all subsequent shared session client requests while the cache is being processed.

In the example of FIG. 18, the transition from state 1810 to “cache exists with queue” 1812 occurs when processing is complete and shared session client A is sent a response. The transition to state 1806 is when the shared session client B requests are dequeued and responses are sent to the one or more shared session clients B.

Advantageously, shared session client requests can be processed at the same time by utilizing the synchronization cache. In a specific implementation in order to capture the same random image for all shared session clients, the first request (which may or may not be the leader) caches first.

An issue related to content cache synchronization is resolving conflicting client requests. Generally, it is desirable to know new and previous locations. For example, if a first shared session client requests google then facebook and a second shared session client requests google, then it may be desirable to send the second shared session client facebook because the second shared session client probably needs to catch up. The sessions of each shared session client are processed simultaneously, but due to environmental conditions, some shared session clients can have slower connections that other shared session clients. If the shared session is passing through multiple pages at a relatively fast pace, shared session clients with slower connections might receive “responses” for content that they have not yet requested.

Frames allow a visual HTML browser window to be split into segments, each of which can show a different document. An inline iframe places another HTML document in a frame. Unlike an object element, an inline frame can be the “target” frame for links defined by other elements and can be selected by a user agent as the focus for printing, viewing its source, etc. There is currently no facility to give iframes unique ids because iframes are controlled by the target site.

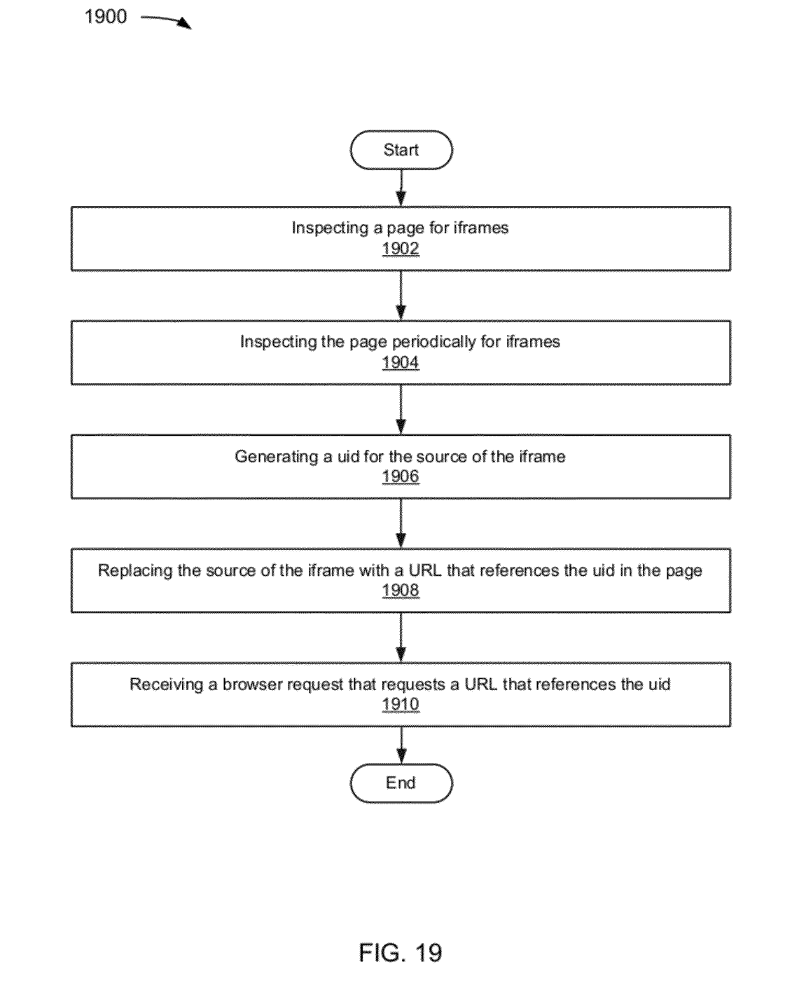

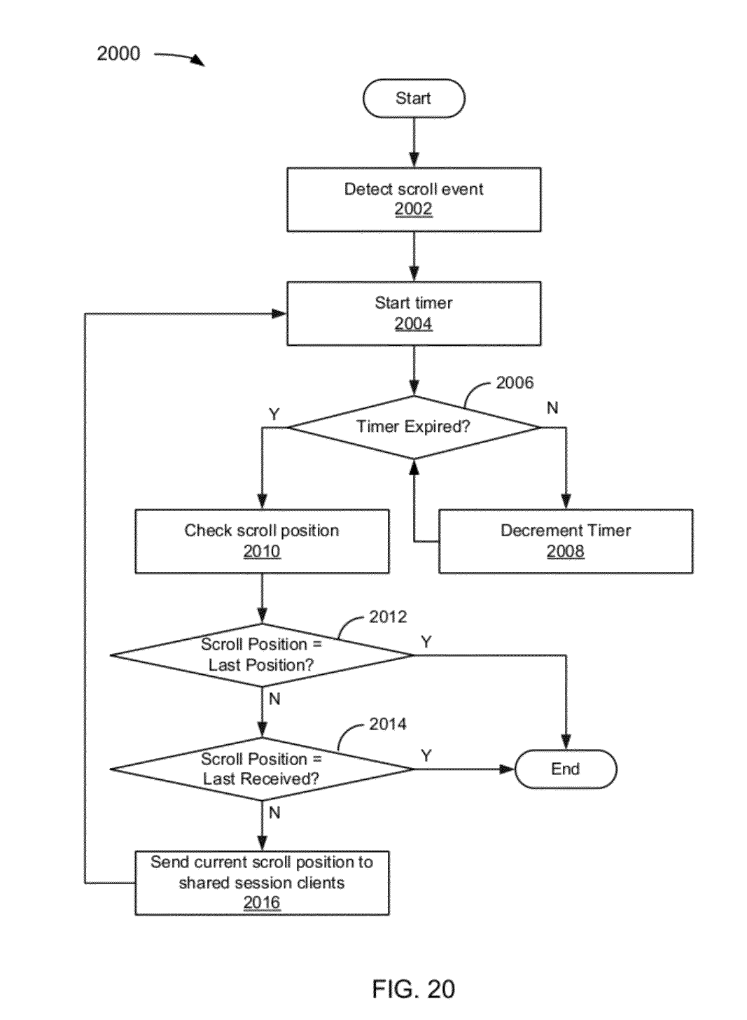

FIG. 19 depicts a flowchart 1900 of an example of a method for handling iframes. In the example of FIG. 19, the flowchart 1900 starts at module 1902 with inspecting a page for iframes. In the example of FIG. 19, the flowchart 1900 continues to module 1904 with inspecting the page periodically for iframes (in case things change). An iframe has a source (e.g., google.ca) and is placed inside a web page. So, for example, an iframe with google.ca as the source and an iframe with facebook.com as the source could co-exist within a web page. It is also possible to have iframes with the same source (e.g., a first iframe with the source google.ca and a second iframe with the source google.ca).

In the example of FIG. 19, the flowchart 1900 continues to module 1906 with generating a unique id (uid) for the source of the iframe. The uid can include an alphanumeric sequence of characters, such as ‘12345.’ Depending upon the implementation, the uid can be a number that is incremented each time a uid is generated.

In the example of FIG. 19, the flowchart 1900 continues to module 1908 with replacing the source of the iframe with a URL that references the uid. For example, the source of the iframe google.com can be replaced with ‘12345.’ Where goinstant.com is a shared session server system, ‘gonstant.com/12345’ can replace google.ca and other combinations of goinstant.com and a uid can replace other iframe sources.

In the example of FIG. 19, the flowchart 1900 ends at module 1910 with receiving a browser request that requests a URL that references the uid. In the ongoing example, the request can include the source ‘goinstant.com/12345.’ The shared session server is aware of the uid that replaced the source of an iframe. (In this example, the source was google.ca.) Thus, the shared session server can redirect the iframe to google.ca upon receipt of the uid.

FIG. 20 depicts a flowchart of an example of a method for handling scrolling events. In the example of FIG. 20, the flowchart 2000 starts at module 2002 with detecting a scroll event. In the example of FIG. 20, the flowchart 2000 continues to module 2004 with starting a timer.

In the example of FIG. 20, the flowchart 2000 continues to decision point 2006 with determining whether the timer has expired. If it is determined that the timer has not expired (2006-N), then the flowchart 2000 continues to module 2008 with decrementing the timer and the flowchart 2000 returns to decision point 2006 until the timer expires. When it is determined that the timer has expired (2006-Y), then the flowchart 2000 continues to module 2010 with checking scroll position.

In the example of FIG. 20, the flowchart 2000 continues to decision point 2012 with determining whether scroll position =last scroll position. If so (2012-Y), then the flowchart 2000 ends without reporting scroll position. If not (2012-N), then the flowchart 2000 continues to decision point 2014 with determining whether scroll position =last received scroll position. If the scroll position is the same as a scroll position that was last received (2014-Y), then the flowchart 2000 ends without reporting scroll position. If not (2014-N), then the flowchart 2000 continues to module 2016 with sending current scroll position to shared session clients, the flowchart 2000 returns to module 2004, and the flowchart 2000 continues as described previously.

Advantageously, by utilizing the above-described technique, scrolling can be accurately shared without getting into a loop when more than one shared session client is scrolling at the same time.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Although the foregoing embodiments have been described in some detail for purposes of clarity of understanding, the invention is not limited to the details provided. There are many alternative ways of implementing the invention. The disclosed embodiments are illustrative and not restrictive.

Text associated with potential future claims follows:

A method comprising: displaying web content; detecting interaction, with a web content element, intended to trigger an event in association with the web content element; determining a permission to interact with the web content element; preventing the interaction from triggering the event when it is determined there is no permission to interact with the web content element; triggering the event when it is determined there is permission to interact with the web content.

A method comprising: establishing a shared browsing session; displaying web content; receiving an indication through a user interface that a shared browsing session is in presenter mode; sending the indication over a network interface data sufficient to display the web content, including changes made to the web content, in real-time to a participant with limited permission to make changes from interacting with the web content. The method, further comprising: tying a permission to a target, event type, user, or a combination of these.

A method comprising: displaying a live web page with a local cursor; receiving a captured sequence of java script events on a network interface; applying a change that will result from a native event firing on a remote device; playing the captured sequence of java script events; overlaying the results of playing the captured sequence of java script events onto the live web page including a remote cursor.

We claim:

1. A method for sharing interactions to the web content, comprising:
displaying web content including an interactive web content element;
capturing all java script events associated with native interactions with the web content;
extracting, from a first java script event of the java script events, event type and target context associated with the interactive web content element;
identifying a change that results from a native interaction of the native interactions with the web content that will not result from the first java script event firing;
sending over a network interface data sufficient to enable display of the web content and results of the native interactions, including target data sufficient to identify the interactive web content element, the target context, the event type, and the change.

2. A method for recreating shared interactions with web content, comprising:
displaying web content including a first interactive web content element;
receiving over a network interface target data sufficient to identify the first interactive web content element, a context, an event type, and change data sufficient to identify a first change;
identifying the first interactive web content element using the target data;
determining whether to apply the first change;
applying the first change to a second interactive web content element;
constructing a java script event from the context and the event type;
dispatching the java script event on the second interactive web content element.

3. The method of claim 2, wherein the first interactive web content element and the second interactive web content element are the same.

4. The method of claim 2, further comprising:
determining whether to apply a second change to the first interactive web content element;
if it is determined to apply the second change:
obtaining data sufficient to apply the second change from any of the target data, the context, the event type, and a combination of these;
applying the second change.

5. The method of claim 2, further comprising:
determining whether to apply a second change to the second interactive web content element;
if it is determined to apply the second change:
obtaining data sufficient to apply the second change from any of the target data, the context, the event type, and a combination of these;
applying the second change.
